(19) United States
(12) Patent Application Publication
(10) Pub. No.: US 2026/0229226 A1
(43) Pub. Date: Aug. 6, 2026

(54) CONVERSATION ASSISTANCE METHOD

(71) Applicant: INTERACTIVE SOLUTIONS CORP., Chiyoda-ku, Tokyo (JP)

(72) Inventor: Kiyoshi SEKINE, Chiyoda, Tokyo (JP)

(73) Assignee: INTERACTIVE SOLUTIONS CORP., Chiyoda-ku, Tokyo (JP)

(21) Appl. No.: 19/115,775

(22) PCT Filed: Sep. 13, 2023
(86) PCT No.: PCT/JP2023/033464

§ 371 Date: Apr. 29, 2025

(30) Foreign Application Priority Data
Sep. 27, 2022 (JP) 2022154281

(51) Int. Cl. G10L 15/08; G10L 15/22

(52) U.S. Cl. CPC G10L 15/08; G10L 15/22

(57) ABSTRACT

[Problem] To automatically break a conversation made by a given speaker down to a plurality of paragraphs (sets of sentences) and classify the paragraphs into paragraph classifications, so as to evaluate the speaker and enable a better conversation. [Solution] A conversation assisting method using a computer, the conversation assisting method, by the computer, comprising: a voice analyzing step of analyzing a voice in a conversation to obtain a voice word, the voice word being a word included in the conversation; a paragraph analyzing step of analyzing the conversation by using the voice word to obtain a paragraph group, the paragraph group being a plurality of paragraphs included in the conversation; a paragraph classifying step of classifying each paragraph included in the paragraph group to obtain paragraph classification data indicating which group each of the paragraphs belongs to; and a paragraph suggesting step of leading a paragraph following the conversation to a paragraph that is classified into a recommended group, by referring to an evaluation value storage unit, reading information about the recommended group by using the paragraph classification data, and outputting a recommended keyword or a sentence including the recommended keyword, the evaluation value storage unit storing an evaluation value of a group, the recommended group being a group that is to follow the conversation, the recommended keyword being stored in association with the recommended group.

### TECHNICAL FIELD

The present invention relates to a conversation assisting method using a computer, and the like.

### BACKGROUND ART

JP 7017822 B2 describes a conversation assisting method using a computer.

### CITATION LIST

### Patent Literature

Patent Literature 1: JP 7017822 B1

### SUMMARY OF INVENTION

### Technical Problem

It is desired to automatically break a conversation made by a given speaker down to a plurality of paragraphs (sets of sentences) and classify the paragraphs into paragraph classifications, so as to evaluate the speaker and enable a better conversation.

Additionally, it is also desirable to guide the speaker to a better conversation.

### Solution to Problem

The above problems are solved basically by a computer automatically classifying a paragraph group included in a conversation to obtain paragraph classification data. This conversation assisting method is a method of automatically providing conversation assistance in a conversation by a computer. Specifically, the conversation assistance is provided by breaking a conversation made by a given speaker down to paragraphs and evaluating the conversation by classifying the paragraphs into paragraph classifications to which the paragraph belongs, so that a better paragraph group can be introduced.

A first aspect of the present invention relates to a conversation assisting method using a computer. In this aspect, the computer performs various steps. This method includes a voice analyzing step, a paragraph analyzing step, a paragraph classifying step, and a paragraph suggesting step.

The voice analyzing step is a step of analyzing voices in a conversation to obtain voice words, which are words included in the conversation.

The paragraph analyzing step is a step of analyzing the conversation using the voice words to obtain a paragraph group, which is a plurality of paragraphs included in the conversation.

The paragraph classifying step is a step of classifying each paragraph included in the paragraph group and classifying the paragraph into a group to which the paragraph belongs. Information indicating which group each paragraph belongs to will also be called paragraph classification data.

An example of the paragraph suggesting step is a step of leading a paragraph following the conversation to a paragraph classified into a recommended group that is to follow the conversation, by referring to an evaluation value storage unit storing the evaluation value of a group, reading information about the recommended group by using the paragraph classification data, and outputting a recommended keyword stored in association with the recommended group or a sentence including the recommended keyword. For example, assume that a conversation is in a first paragraph, and the first paragraph belongs to a first group. The evaluation value storage unit stores the evaluation value of each of a plurality of groups that follow the first group. The evaluation value is a value that increases as the conversation becomes better. For example, a plurality of conversations and the evaluations of the plurality of conversations from users may be compiled, and this value may be determined such that a high evaluation value is given to a conversation that is highly evaluated and may be stored in the evaluation value storage unit. Assume that the evaluation value storage unit stores a second group as a highest-evaluation-value group that follows the first group. Then, the second group is the recommended group. The storage unit stores one or more recommended keywords in association with the recommended group (second group). As a result, the computer can read the one or more recommended keywords from the storage unit and directly output them or can create a sentence by using the one or more recommended keywords (or read the sentence stored in the storage unit) and output the sentence.

In a preferable example of this aspect, the paragraph analyzing step is a step of, by using the voice word included in each paragraph included in the paragraph group and using information about a paragraph analysis keyword, obtaining a paragraph group, the paragraph analysis keyword being for analyzing a paragraph on a basis of a voice word.

In a preferable example of this aspect, each paragraph included in the paragraph group corresponds to a presentation material or a page of a presentation material.

A second aspect of the present invention includes a voice analyzing step, a paragraph analyzing step, a paragraph classifying step, and a paragraph suggesting step. The paragraph suggesting step in the second aspect is a paragraph suggesting step of referring to an evaluation value storage unit storing an evaluation value of a group, obtaining an evaluation value of the conversation by using the paragraph classification data, and outputting, when a group sequence with a higher evaluation value than the evaluation value of the conversation is present, a keyword stored in association with a group sequence that makes an evaluation value high or a sentence including the keyword. For example, assume that the conversation includes a group 1, a group 2, and a group 3 in this order. The evaluation value storage unit stores the evaluation value of the case where the group 1, the group 2, and the group 3 are included in this order. At the same time, the evaluation value storage unit stores the evaluation value of the case where the group 1, the group 2, a group 4, and a group 5 are included in this order. When the latter evaluation value is higher than the former evaluation value, a system obtains information about groups included in the conversation (including the group 1, the group 2, and the group 3 in this order) by using the paragraph classification data and reads the evaluation value of the conversation from the evaluation value storage unit. The system then reads information about a group sequence (including the group 1, the group 2, the group 4, and the group 5 in this order) with a higher evaluation value than the evaluation value of the conversation read from the evaluation value storage unit and outputs a keyword that is stored in association with each group in this group sequence. At this time, the system may create and output a sentence by using the read keyword. The system may output a sentence that is stored in association with each group in this group sequence. In this case, when the groups included in the conversation and the groups included in a group sequence with a high evaluation value include the same group, a keyword stored in association with a group that is of the groups included in the group sequence with the high evaluation value and is not included in the conversation may be output, or a sentence including such a keyword may be output.

A preferable example of this aspect further includes a step of displaying group sequences included in the conversation, a keyword included in each of the group sequences included in the conversation, group sequences that make the evaluation value high, and a keyword included in each of the group sequences that make the evaluation value high.

A preferable example of this aspect further includes a step of displaying a change in evaluation value for each of group sequences included in the conversation and a change in evaluation value for each of group sequences that make the evaluation value high.

Other aspects of the invention according to the present description relate to a program for causing a computer to execute any one of the above aspects and a non-transitory information recording medium storing this program.

### Advantageous Effects of Invention

According to the present invention, it is possible to automatically break a conversation of a given speaker down to a plurality of paragraphs (sets of sentences) and classify the paragraphs into paragraph classifications.

In addition, according to the present invention, it is possible to evaluate a conversation on a per-paragraph basis and output, for each paragraph, a better paragraph or a keyword included in the better paragraph, so as to lead the conversation to an improved conversation.

### BRIEF DESCRIPTION OF DRAWINGS

FIG. 1 is a flowchart for describing a conversation assisting method using a computer.

FIG. 2 is a block diagram of a conversation assisting device that implements the conversation assisting method.

FIG. 3 is a conceptual diagram illustrating an example of keywords included in each paragraph.

FIG. 4 is a graph that visualizes the evaluation of a conversation and the evaluations of virtual conversations after the suggestion of paragraphs.

### DESCRIPTION OF EMBODIMENT

An embodiment for practicing the present invention will be described below with reference to the drawings. The present invention is not limited to the embodiment described below but also includes modifications that are made by those skilled in the art as appropriate within a scope obvious to those skilled in the art from the following embodiment.

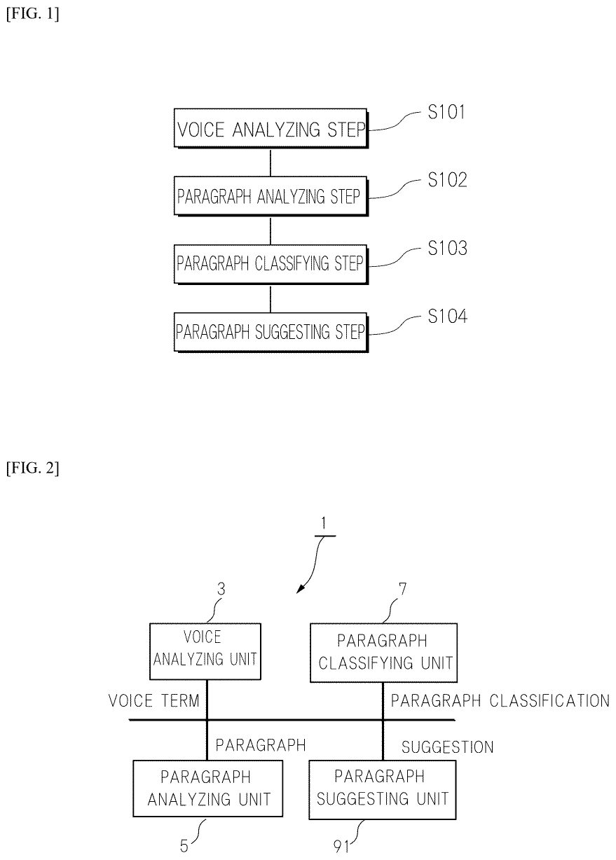

FIG. 1 is a flowchart for describing a conversation assisting method using a computer.

As illustrated in FIG. 1, the conversation assisting method using a computer includes a voice analyzing step (S101), a paragraph analyzing step (S102), and a paragraph classifying step (S103). The conversation assisting method using a computer may further include a paragraph suggesting step (S104). S denotes a step.

FIG. 2 is a block diagram of a conversation assisting device that implements this method. As illustrated in FIG. 2, a conversation assisting device 1 that implements this method is a computational device. The conversation assisting device 1 may include a voice analyzing unit 3 that performs the voice analyzing step (S101), a paragraph analyzing unit 5 that performs the paragraph analyzing step (S102), and a paragraph classifying unit 7 that performs the paragraph classifying step (S103). This device may include a paragraph suggesting unit 9 that performs the paragraph suggesting step (S104). Each of the units may be interpreted as means.

The computer includes an input unit, an output unit, a control unit, a computation unit, and a storage unit, and the elements are connected together with a bus or the like so as to exchange information with one another. For example, the storage unit may store a control program and may store various types of information. When predetermined information is input from the input unit, the control unit reads the control program stored in the storage unit. The control unit then reads information stored in the storage unit and transfers the information to the computation unit as appropriate. The control unit also transfers the input information to the computation unit as appropriate. The computation unit performs computational processing using received various types of information and stores a computation result in the storage unit. The control unit reads the computation result stored in the storage unit and outputs the computation result through the output unit. In this manner, various types of processing and steps are executed. The various types of processing are executed by the units and means. The computer may be a computer including a processor that implements various functions and various steps. The computer may be a standalone computer. Some of the functions of the computer may be decentralized into a server and a terminal. In this case, the server and the terminal are preferably made capable of exchanging information over a network such as the Internet or an intranet.

### Voice Analyzing Step (S101)

The voice analyzing step is a step of analyzing, by the computer, voices in a conversation to obtain voice words, which are words included in the conversation. The conversation may be any one of a business talk, an explanation of a given commercial product, or a presentation. The following example describes a conversation among a plurality of persons. However, the conversation also includes a speech by one person (a presentation, etc.). Voice information on the conversation or digital information based on the conversation is input via the input unit (a microphone or an interface) of the conversation assisting device (computer). The input information about the conversation is stored in the storage unit of the computer as appropriate. The computer reads the information about the conversation from the storage unit and a program from the storage unit and analyzes voices in the conversation, thus obtaining voice words, which are words included in the conversation. At this time, the computer may refer to a dictionary included in the storage unit as appropriate. In the case where the conversation is based on a presentation, the storage unit may store a specific dictionary that stores terms relating to the presentation, and the specific dictionary may be referred to so as to obtain correct voice words in the voice analyzing step. The following is an example of the voice words.

MR) Doctor, thank you for your time today.

I have come today to introduce to you a newly-marketed DPP4 inhibitor, AIPURO tablet.

Dr.) (Although) there are already similar medicines, another new one has come out? I do not intend to use new DPP4 inhibitors anymore.

MR) Doctor, it is true that several DPP4 inhibitors are already available, but our AIPURO tablet is excellent compared with the other medicines.

What type of DPP4 inhibitor do you use now?

Dr.) There are many. So, I use different DDP4 inhibitors depending on patients' lifestyles.

Recently, I have often prescribed PUCHIN tablets, I think. Because PUCHIN produces a strong effect with one dose.

MR) I see. Our AIPURO tablet has a very high selectivity for DPP4,

80 times compared with the selectivity of PUCHIN tablet.
This is why it tends to produce a stronger glucose-lowering effect than PUCHIN tablet in their effectiveness.

Dr.) But that MR said that “the selectivity has no relation to the effect.”

Is AIPURO tablet more effective than PUCHIN tablet?

MR) Yes. The amount of change in HbA1c from baseline with AIPURO tablet is 0.9%.

In contrast, with PUCHIN tablet, it is about 0.5%.

The more selective a medicine, the more effective it is, and you can use a smaller dosage of it, resulting in high safety.

Dr.) I see. It looks like this is highly effective. I will consider using this.

MR) Please consider prescribing it to patients who have difficulty in glycemic control.

In the above, the computer may distinguish between speakers (the MR and Dr) based on the frequencies of voices in the conversation, or a voice input unit (microphone, etc.) may or may not distinguish between them.

### Paragraph Analyzing Step (S102)

The paragraph analyzing step is a step of, by the computer, analyzing a conversation by using voice words to obtain a paragraph group, which is a plurality of paragraphs included in the conversation. A paragraph is a set of sentences each having some meaning. Breaking the conversation down into paragraphs may be performed such that every change of a speaker is taken as the start of a new paragraph. A given conversation is formed by a paragraph group including, for example, n paragraphs such as a first paragraph, a second paragraph, . . . . For example, the computer can perform the analysis such that an m-th paragraph has been spoken in the case where one or more keywords included in the m-th paragraph are stored in the storage unit and the computer understands that a predetermined number or more of the keywords are included in the voice words. A typical conversation progresses through a first paragraph, a second paragraph, . . . . Thus, the computer can perform such a method that after understanding that the first paragraph has been spoken, the computer reads a keyword about the second paragraph and analyzes whether the keyword is included in the voice words. In this manner, the computer can automatically analyze a given conversation and break it down to a plurality of paragraphs.

In the case where Web interviews are held among a plurality of groups, the Web interviews have similar conversations. The computer evaluates conversations according to an evaluation method described later and groups the conversations by using voice words included in the similar conversations stored in the storage unit, and the conversations are classified into successful conversations and the other conversations. In this manner, the computer may determine a paragraph group included in a conversation, the classes of paragraphs, and keywords included in each of the classes and store the paragraph group, the classes, and the keywords in the storage unit.

In addition, for example, the computer may extract words included in each page of a presentation material and prepare a page-related-word database that stores information about each page (e.g., a page B of a presentation A) and words relating to the page and related words of the words. Thereafter, the paragraph analyzing unit of the computer may check voice words against the page-related-word database to learn which page a conversation or a presentation touches on and may sort the voice words into paragraphs.

A preferable example of the paragraph analyzing step is to obtain a paragraph group by using voice words and information about keywords included in each of a plurality of paragraphs included in a conversation. The keywords included in each paragraph are preferably obtained by comparing a plurality of conversations and analyzing keywords included in the paragraph. That is, a system stores, in the storage unit, conversations or presentations made by a plurality of persons using a given presentation material or a given topic (e.g., a given commercial product). The system then determines voice words included in the conversations or the presentations and stores the voice words in the storage unit. At this time, the voice words may be stored in association with pages of the presentation material. Thereafter, the system may determine the matching or unmatching of voice words included in a plurality of conversations or presentations to determine paragraphs and keywords (voice words) included in each of the paragraphs on a per-class basis and may store the paragraphs and the keywords in the storage unit. In addition, the system may determine voice words used in each page of the presentation material, analyze the pattern of the voice words to determine the class of the page, and store characteristic voice words of each class in the storage unit as keywords.

As a method of breaking down to paragraphs, a conversation made by a plurality of speakers may be analyzed, and sets with distinct terms may be distinguished as paragraphs. This breaking-down-to-paragraph method may be automatically performed by the computer comparing recorded voice words, and classification words for classifying paragraphs (keywords) may be stored in the storage unit for each paragraph. For example, the utterance “excellent” may be treated as an inappropriate word. That is, classification words may include an inappropriate word, or an inappropriate word may be stored in the storage unit as a type of keyword. The inappropriate word means a term that is intrinsically not desirable to use (should not be used).

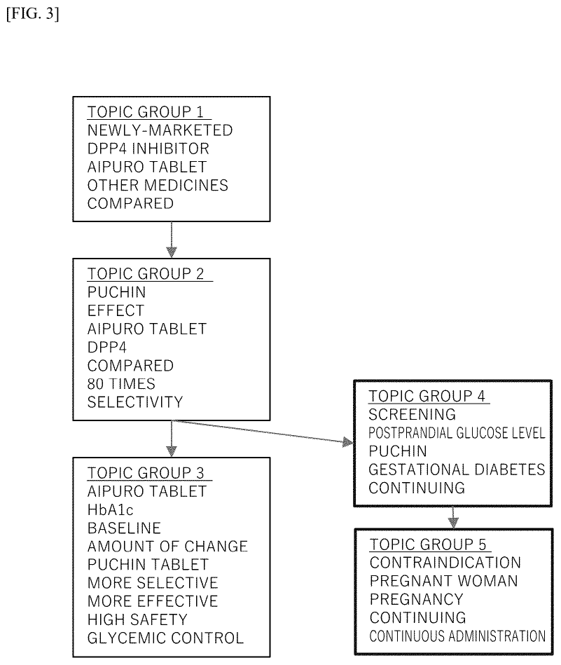

FIG. 3 is a conceptual diagram illustrating an example of keywords included in each paragraph. In the example in FIG. 3, paragraphs indicated by topic groups 1 and 2 are followed by different paragraphs (and keywords sorted into the paragraphs). The computer can then classify the paragraphs following the paragraphs indicated by the topic groups 1 and 2 of the conversation by comparing voice words included in the paragraphs following the paragraphs indicated by the topic groups 1 and 2 with the keywords stored in the storage unit. Speakers of utterances in the conversation may be analyzed, and the paragraphs may be analyzed and classified on the basis of only utterances of a given speaker.

Each of the plurality of paragraphs preferably corresponds to a presentation material or a page of a presentation material. In this case, for the presentation material or for each page of the presentation material, keywords for classification into paragraph classes can be stored in the storage unit, and paragraphs can be analyzed (and classified) using the keywords. For example, assume the first page of the presentation material contains the paragraphs that can be classified into paragraph classes 1 to 3. In association with the first paragraph class, a keyword A_{1,1,1}, a keyword A_{1,1,2}, a keyword A_{1,1,3}, a keyword A_{1,1,4}, . . . are stored, and in association with the second paragraph class, a keyword A_{1,2,1}, a keyword A_{1,2,2}, a keyword A_{1,2,3}, a keyword A_{1,2,4}, . . . are stored. Some of the keywords pertaining to these different paragraph classes may be the same. By using such keyword groups, paragraphs included in a conversation can be analyzed and classified.

An example of the paragraph analyzing step is as follows. Using keywords for this classification enables voice analysis to be performed more accurately.

### Topic Group 1 (First Paragraph)

MR) Doctor, thank you for your time today.

I have come today to introduce to you a “newly-marketed” “DPP4 inhibitor”, “AIPURO tablet.”

Dr.) (Although) there are already similar medicines, another new one has come out? I do not intend to use new DPP4 inhibitors anymore.

MR) Doctor, it is true that several DPP4 inhibitors are already available, but our AIPURO tablet is excellent “compared” with the “other medicines.”

What type of DPP4 inhibitor do you use now?

Dr.) There are many. So, I use different DDP4 inhibitors depending on patients' lifestyles.

Recently, I have often prescribed PUCHIN tablets, I think. Because PUCHIN produces a strong effect with one dose.

In this example, as keywords pertaining to the topic group 1 of the first paragraph, the terms including “newly-marketed,” “DPP4 inhibitor,” “AIPURO tablet,” “other medicines,” and “compared” are stored in the storage unit. The computer compares the voice words with the keywords and analyzes the above part of the conversation as (the topic group 1 of) the first paragraph. In the above example, the words enclosed in the double quotation marks are voice words that match the keywords pertaining to the topic group 1.

### Topic Group 2 (Second Paragraph)

MR) I see. Our “AIPURO tablet” has a very high selectivity for DPP4, “80 times” compared with the “selectivity” of “PUCHIN” tablet.

This is why it tends to produce a stronger glucose-lowering effect than PUCHIN tablet in their effectiveness.

Dr.) But that MR said that “the selectivity has no relation to the effect.”

Is AIPURO tablet more effective than PUCHIN tablet?

### Topic Group 3 (Third Paragraph)

MR) Yes. The “amount of change” in “HbA1c” from “baseline” with “AIPURO tablet” is 0.9%.

In contrast, with PUCHIN tablet, it is about 0.5%.

The more selective a medicine, the more “effective” it is, and you can use a smaller dosage of it, resulting in high “safety.”

Dr.) I see. It looks like this is highly effective. I will consider using this.

MR) Please consider prescribing it to patients who have difficulty in “glycemic control.”

### Paragraph Classifying Step (S103)

The paragraph classifying step is a step of, by the computer, classifying paragraphs included in a paragraph group to obtain paragraph classification data. When the paragraphs included in the paragraph group are grouped into some groups, the paragraph classification data means information on which group each paragraph belongs to. By using this information, the paragraphs can be classified.

As a preferable example of the paragraph classifying step, the plurality of paragraphs included in the conversation are classified into two or more paragraph classes by using a plurality of keywords included in each of the plurality of paragraphs included in the conversation, and the plurality of paragraphs included in the conversation are classified based on whether a voice word matches a keyword in any one of the two or more paragraph classes. In the example described earlier, paragraphs are classified in the paragraph analyzing step.

The paragraph classifying step may be performed concurrently with the paragraph analyzing step or may be performed separately from the paragraph analyzing step. As an example in which the paragraph classifying step is performed separately from the paragraph analyzing step, a paragraph classification storage unit that stores paragraph classification keywords for determining which group each paragraph belongs to may be included, and which group each paragraph belongs to may be analyzed by checking a voice word included in the paragraph against the paragraph classification keywords.

For example, in the above example, for the first paragraph, the paragraph classifying unit may refer to the paragraph classification storage unit by using voice words included in the first paragraph and determine that the first paragraph belongs to a first group, for the second paragraph, the paragraph classifying unit may refer to the paragraph classification storage unit using voice words included in the second paragraph and determine that the second paragraph belongs to a second group, and for the third paragraph, the paragraph classifying unit may refer to the paragraph classification storage unit using voice words included in the third paragraph and determine that the third paragraph belongs to a third group.

### Paragraph Suggesting Step (S104)

The paragraph suggesting step is a step of, by the computer, suggesting a highly-evaluated paragraph, which is more highly evaluated, for one or more paragraphs included in a paragraph group on the basis of the paragraph classification data. By this step, it becomes possible to recommend an example of a speaker who is more highly evaluated. For example, in the case where a given paragraph is classified into five classes, and when a class given a higher evaluation value than a class of a speech by a speaker is present, it is possible to lead the speaker to a better conversation by suggesting the class with the higher evaluation value. In this case, an evaluation value may be stored in the storage unit in association with each paragraph classification, and a paragraph with a high evaluation value or keywords pertaining to the paragraph may be output after the determination of which class a paragraph belongs to. As an example of the outputting, the paragraph with the high evaluation value or the keywords pertaining to the paragraph are displayed on a display unit. This enables a speaker of a conversation to learn, for each paragraph, a paragraph with a high evaluation value or keywords pertaining to the paragraph and put them to good use in the next explanation or presentation.

For example, the system includes an evaluation value storage unit that stores the evaluation values of groups.

The paragraph suggesting unit receives, from the paragraph classifying unit, information indicating that the first paragraph belongs to the first group. The evaluation value storage unit stores the second group as a group that follows the first group. That is, the evaluation value storage unit stores a conversation in which the second group follows the first group as a conversation that is more highly evaluated than a conversation in which another group follows the first group. The paragraph suggesting unit then outputs recommended keywords or a sentence including the recommended keywords that are stored in association with the second group, in the middle of or after a presentation (conversation) about the first group. Then, the recommended keywords or the sentence including the recommended keywords is output to a terminal. In this manner, this system can assist a presenter in such a manner that the presenter speaks the second group subsequently to the first group.

The evaluation value storage unit stores the evaluation value of the case where the third group is spoken subsequently to the first group and the second group. The evaluation value storage unit further stores the evaluation value of the case where a fourth group and a fifth group are spoken subsequently to the first group and the second group. When the latter is higher, the paragraph suggesting unit receives, from the paragraph classifying unit, information indicating that the second paragraph after the first group belongs to the second group. The paragraph suggesting unit then outputs recommended keywords that are stored in association with the fourth group or a sentence including the recommended keywords, in the middle of or after a presentation (conversation) about the second group. Then, the recommended keywords or the sentence including the recommended keywords is output to a terminal. In this manner, this system can assist a presenter in such a manner that the presenter speaks the fourth group subsequently to the second group.

A method and a device that evaluate a conversation (including a presentation) are known. For example, JP 7049010 B1 describes a presentation evaluation system. This system includes a voice analysis unit that analyzes the content of a conversation, a presentation-material-related information storage unit that stores information being about a presentation material and including information for identifying each page of the presentation material, a keyword storage unit that stores a keyword in each page of the presentation material, a related word storage unit that stores a related word of the keyword, and an evaluating unit that evaluates a content of a conversation analyzed by the voice analysis unit or a person who have had the conversation. The evaluating unit identifies each page of the presentation material on the basis of the information about the presentation material stored in the presentation-material-related information storage unit, reads a keyword pertaining to the identified page of the presentation material from the keyword storage unit, reads a related word of the keyword pertaining to the identified page of the presentation material from the related word storage unit, reads and obtains an evaluation value pertaining to the count of keywords of each page of the presentation material included in the content of the conversation analyzed by the voice analysis unit, an evaluation value pertaining to the count of related words of the keyword pertaining to the identified page of the presentation material, an evaluation value pertaining to the combination of keywords pertaining to the identified page of the presentation material, or an evaluation value pertaining to the combination of related words of the keyword pertaining to the identified page of the presentation material from the storage unit by using a count of keywords of each page of the presentation material included in the content of the conversation analyzed by the voice analysis unit, a count of related words of the keyword pertaining to the identified page of the presentation material, a combination of keywords pertaining to the identified page of the presentation material, or a combination of related words of the keyword pertaining to the identified page of the presentation material, and determines an evaluation value for evaluating the content of the conversation or a person who have had the conversation by using the read evaluation value or using, when a plurality of evaluation values are read, the total of read evaluation values. In this manner, a conversation (presentation) and paragraphs can be evaluated. The determined evaluation value can be stored in the storage unit as appropriate.

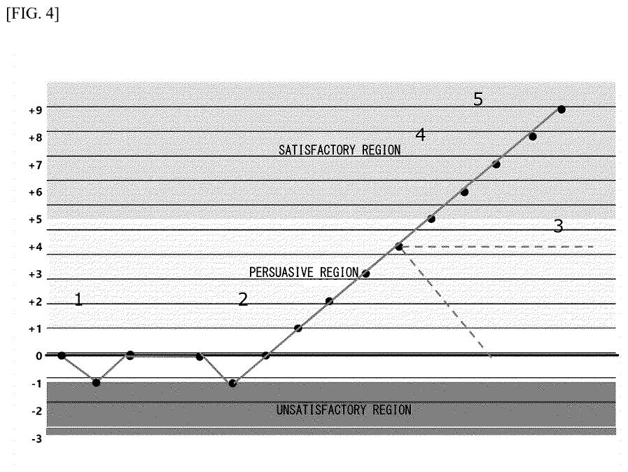

FIG. 4 is a graph that visualizes the evaluation of a conversation and the evaluations of virtual conversations after the suggestion of paragraphs. In this example, the result of an analysis by the computer shows that a given conversation has progressed through the topic group 1, the topic group 2, and the topic group 3. The third paragraph is given a higher evaluation value when the third paragraph progresses through a topic group 4 and a topic group 5 rather than through the topic group 3. The computer stores the evaluation value of a class included in each paragraph. Thus, the computer reads and compares the evaluation value of the topic group 3 included in the third paragraph and the evaluation values of the topic group 4 and the topic group 5 included in the third paragraph and outputs keywords included in the topic group 4 and the topic group 5. In addition, the computer reads the evaluation values of the paragraphs, determines changes in evaluation value in the actual conversation and changes in evaluation value of the case of a virtual conversation based on the suggestion of paragraphs, and outputs them in the forms of a graph. In this manner, it becomes possible to lead a conversation or a presentation in accordance with better paragraphs, and the effects of the better paragraphs can be visually checked through the visualization. Thus, it becomes possible to make the suggestion persuasive for a speaker.

In addition, presentation examples based on the same presentation material are collected and broken down to paragraphs, and then the paragraphs are grouped. Then, changes in group in a presentation (conversation) having a good reputation are stored in the storage unit. In this manner, the evaluation value storage unit storing the evaluation values of groups can be updated. For example, the evaluation value storage unit stores changes in evaluation value (see FIG. 4) in association with a presentation that progresses through groups 1, 2, 4, and 5. In addition, the evaluation value storage unit stores changes in evaluation value (see FIG. 4) in association with a presentation that progresses through groups 1, 2, and 3. As seen from the above, by causing a plurality of persons to make a given presentation (conversation), breaking the resultant presentations down to a plurality of groups, and storing the evaluation values of the groups, it is possible to update the flow of groups in speeches by persons who have made good presentations, and in the case where the evaluation value of a presentation by a given speaker is lower than the evaluation value of the good presentation, it is possible to guide the speaker to a group that is given a higher evaluation value. In the above example, in the case where the system determines that the presentation has progressed through the groups 1 and 2, in order to lead the presentation to the groups 4 and 5, the system displays keywords included in the group 4 on a terminal of a presenter during the presentation, so that it becomes possible to guide the presenter to a highly evaluated presentation.

In the case where an actual conversation (presentation) has progressed through the group 1, the group 2, and the group 3, the paragraph suggesting unit reads, from the evaluation value storage unit, information about a presentation that progresses through the groups 1, 2, 4, and 5 and has a higher evaluation value than an evaluation value relating to a presentation that progresses through the groups 1, 2, and 3. The paragraph suggesting unit then outputs the flow of the groups that can be more highly evaluated than the actual conversation, as illustrated in FIG. 3. In this manner, it is possible after an actual conversation to provide assistance in making a more highly evaluated conversation. Furthermore, by outputting changes in evaluation value as illustrated in FIG. 4, it is possible to lead a good conversation more persuasively.

A program according to the present invention is for causing the computer to implement the above method. The program according to the present invention is a program for causing the computer to execute the method including the voice analyzing step, the paragraph analyzing step, and the paragraph classifying step. The program according to the present invention may be a program for causing the computer to further execute the paragraph suggesting step.

A non-transitory information recording medium according to the present invention is a non-transitory computer-readable information recording medium storing the above program. Examples of the non-transitory information recording medium include a CD-ROM, a DVD, and a USB memory.

The present invention can be implemented in the form of, for example, an application program in a user's terminal. For example, a user (A) retries a Web interview on the application using conversation/role-play data on the Web interview. Then, a terminal in which this application is installed recommends (keywords in) highly-evaluated paragraphs by other persons (B and C) and displays the (keywords in) the highly-evaluated paragraphs on a display unit of the terminal. Subsequently, when the user selects a response example of B, a paragraph that is evaluated lower than paragraphs by the other persons in a conversation by A is changed to a paragraph spoken by B. Listening to the conversation subjected to this change, the user A can learn a conversation that is more highly evaluated. This processing can be performed by the computer. As seen from the above, conversations are stored in the storage unit on a per-paragraph basis, when a paragraph that is made by another person and highly evaluated (highly-evaluated paragraph) is present, and when a paragraph that is included in a given conversation and is a part lower evaluated than the paragraph made by the other person (low-evaluated paragraph) is present, the computer may display keywords included in the paragraph that is made by the other person and highly evaluated on the display unit or may replace the low-evaluated paragraph with the highly-evaluated paragraph and store the highly-evaluated paragraph. At this time, (the frequency band of) a voice of the highly-evaluated paragraph replaced with may be converted into (the frequency band of) a voice of a given speaker, and the voice converted into may be stored in the storage unit. In this manner, it becomes possible to play back a conversation in which the low-evaluated paragraph is replaced with the highly-evaluated paragraph.

### INDUSTRIAL APPLICABILITY

The present invention may be used in information industries.

### REFERENCE SIGNS LIST

1 conversation assisting device
3 voice analyzing unit
5 paragraph analyzing unit
7 paragraph classifying unit
9 paragraph suggesting unit

1. A conversation assisting method using a computer, the conversation assisting method, by the computer, comprising:
a voice analyzing step of analyzing a voice in a conversation to obtain a voice word, the voice word being a word included in the conversation;
a paragraph analyzing step of analyzing the conversation by using the voice word to obtain a paragraph group, the paragraph group being a plurality of paragraphs included in the conversation;
a paragraph classifying step of classifying each paragraph included in the paragraph group to obtain paragraph classification data indicating which group each of the paragraphs belongs to; and
a paragraph suggesting step of leading a paragraph following the conversation to a paragraph that is classified into a recommended group, by referring to an evaluation value storage unit, reading information about the recommended group by using the paragraph classification data, and outputting a recommended keyword or a sentence including the recommended keyword, the evaluation value storage unit storing an evaluation value of a group, the recommended group being a group that is to follow the conversation, the recommended keyword being stored in association with the recommended group.

2. The method according to claim 1, wherein the paragraph analyzing step is a step of, by using the voice word included in each paragraph included in the paragraph group and using information about a paragraph analysis keyword, obtaining the paragraph group, the paragraph analysis keyword being for analyzing a paragraph on a basis of a voice word.

3. The method according to claim 1, wherein each paragraph included in the paragraph group corresponds to a presentation material or a page of a presentation material.

4. A conversation assisting method using a computer, the conversation assisting method, by the computer. comprising: a voice analyzing step of analyzing a voice in a conversation to obtain a voice word, the voice word being a word included in the conversation;
a paragraph analyzing step of analyzing the conversation by using the voice word to obtain a paragraph group, the paragraph group being a plurality of paragraphs included in the conversation;
a paragraph classifying step of classifying each paragraph included in the paragraph group to obtain paragraph classification data indicating which group each of the paragraphs belongs to; and
a paragraph suggesting step of referring to an evaluation value storage unit, obtaining an evaluation value of the conversation by using the paragraph classification data, and outputting, when a group sequence with a higher evaluation value than the evaluation value of the conversation is present, a keyword or a sentence including the keyword, the evaluation value storage unit storing an evaluation value of a group, the keyword being stored in association with a group sequence that makes an evaluation value high.

5. The method according to claim 4, further comprising a step of displaying group sequences included in the conversation, a keyword included in each of the group sequences included in the conversation, group sequences that make the evaluation value high, and a keyword included in each of the group sequences that make the evaluation value high.

6. The method according to claim 4, further comprising a step of displaying a change in evaluation value for each of group sequences included in the conversation and a change in evaluation value for each of group sequences that make the evaluation value high.

7. A program for causing a computer to execute a method comprising:
a voice analyzing step of analyzing a voice in a conversation to obtain a voice word, the voice word being a word included in the conversation;
a paragraph analyzing step of analyzing the conversation by using the voice word to obtain a paragraph group, the paragraph group being a plurality of paragraphs included in the conversation;
a paragraph classifying step of classifying each paragraph included in the paragraph group to obtain paragraph classification data indicating which group each of the paragraphs belongs to; and
a paragraph suggesting step of leading a paragraph following the conversation to a paragraph that is classified into a recommended group, by referring to an evaluation value storage unit, reading information about the recommended group by using the paragraph classification data, and outputting a recommended keyword or a sentence including the recommended keyword, the evaluation value storage unit storing an evaluation value of a group, the recommended group being a group that is to follow the conversation, the recommended keyword being stored in association with the recommended group.

8. A non-transitory information recording medium storing the program according to claim 7.
